(19) United States
(12) Patent Application Publication
(10) Pub. No.: US 2007/0282722 A1
(43) Pub. Date: Dec. 6, 2007

(54) Retrieving data to automatically populate a timesheet dataset

(75) Inventors: R. David Ducolon, Auburn, WA (US); Xiaoning Fu, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/443,776

(22) Filed: May 31, 2006

(51) Int. Cl. G07C 1/10

(52) U.S. Cl. 705/32

(57) ABSTRACT

Methods, systems, and computer program products retrieve data to automatically populate a timesheet dataset. A method involves creating a timesheet via a read of time phased data from a binary large object (BLOB) therein initializing a timesheet dataset, reading current assignments associated with the timesheet into the timesheet dataset, and preparing a timesheet line associated with the timesheet based on a single assignment for a timesheet user therein populating the timesheet dataset and enabling access to the timesheet dataset after compilation. The method also involves identifying days off associated with the timesheet user via a read of calendar data from a calendar BLOB and populating the days off identified to the timesheet dataset with an indicator that the days off are non-working days for the timesheet user.

### COPYRIGHT NOTICE

A portion of the disclosure of this patent document contains material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### BACKGROUND

With the advent of the computer age, computer and software users who work as employees and/or professionals have grown accustomed to software applications that help them plan, enter, and account for their time worked. However, timesheet applications generally do not provide accurate information to the users on what work was already planned for them during a timesheet period. For some conventional project applications, such as MICROSOFT OFFICE PROJECT SERVER, from Microsoft Corporation of Redmond, Wash., scheduled work is already contained in a project file but is not given to users in an automated manner to populate their timesheets. Prior versions of these conventional project applications fail to show only work planned or reported during a timesheet period. Instead these versions often track or show work assignments that do not necessarily match or fit into the discrete time periods of a timesheet.

Thus, because data is not supplied for a user interface timesheet to track or bill work against, conventional partner or independent timesheet applications provide an incomplete picture of planned and executed work in the timesheet. Users can access assigned project tasks but they do not necessarily know when people are scheduled to work on the tasks or on which days and how much work actually occurs. Users only know how much progress or effort was put against a task not how much work was actually done. Also, applications that partner with these conventional project applications to provide timesheet functionality are unable to populate data stored within the project applications in binary format. Thus, pre-populated formatted information cannot be transferred to the timesheets.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments of the present invention solve the above and other problems by providing for retrieving data to automatically populate a timesheet dataset. Embodiments of the present invention are unique in that they read a binary project file and determine what work was planned and/or reported for or by a user on specific days within a timesheet period. Embodiments also automatically populate this data in the user's timesheet. Also, timesheet users are provided the ability to reset any given task on the timesheet with the planned or reported work even after making modifications to the original planned or reported work in the timesheet. These embodiments can produce an industry compliant timesheet by automatically populating only planned or reported work associated with a given day of the timesheet period.

One embodiment is a method for retrieving pre-populated data from a project file to automatically populate a timesheet dataset of an underlying application call. The method involves creating a timesheet via a read of time phased data from a binary large object (BLOB) therein initializing a timesheet dataset, reading current assignments associated with the timesheet into the timesheet dataset, and preparing a timesheet line associated with the timesheet based on a single assignment for a timesheet user therein populating the timesheet dataset and enabling access to the timesheet dataset after compilation. The method also involves identifying days off associated with the timesheet user via a read of calendar data from a calendar BLOB and populating the days off identified to the timesheet dataset with an indicator that the days off are non-working days for the timesheet user.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 illustrates an exemplary computing system; and

FIG. 2 illustrates an illustrative routine performed in retrieving data to automatically populate a timesheet dataset.

### DETAILED DESCRIPTION

As briefly described above, embodiments of the present invention are drawn to retrieving data to automatically populate a timesheet dataset. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

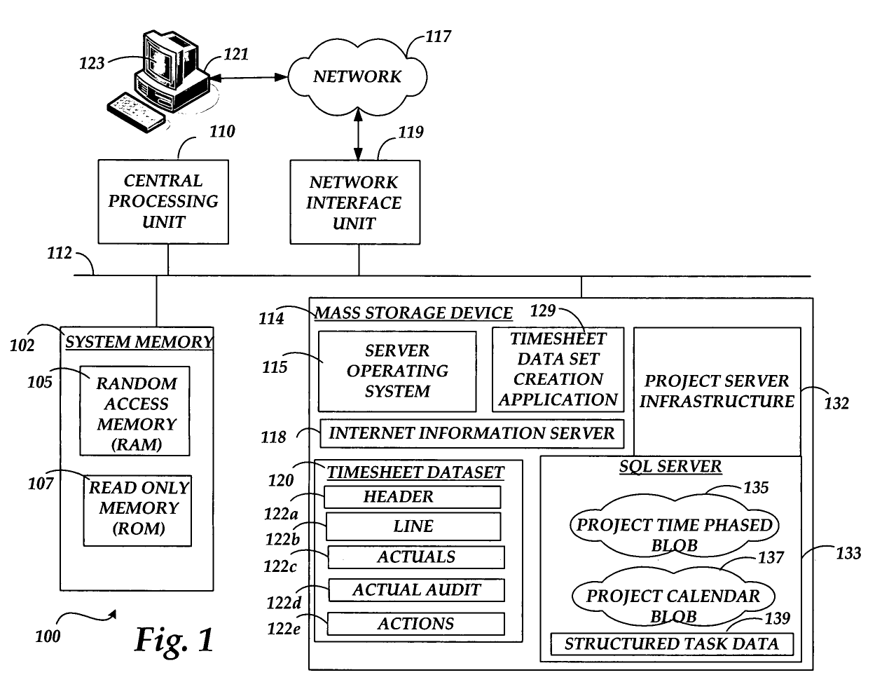

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand- held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the invention includes a server computing device, such as computing device 100. In a basic configuration, the computing device 100 typically includes at least one processing unit 110, system memory 102, and a mass storage device (MSD) 114. Depending on the exact configuration and type of computing device, the system memory 102 may be volatile (such as RAM 105), non-volatile (such as ROM 107, flash memory, etc.) or some combination of the two. The MSD 114 typically includes a server operating system 115, such WINDOWS 2003 SERVER from Microsoft Corporation, suitable for controlling the operation of a networked server computer. The MSD 114 may also include one or more software applications, such as a timesheet dataset creation application (TDCA) 129, and Internet information server (IIS) 118 working in conjunction with a project server infrastructure 132, a timesheet dataset 120, and a database server, such as a SQL® server 133 from Microsoft Corporation.

The timesheet dataset includes timesheet table definitions 122 including individual definitions for a header 122a, a timesheet line 122b, actual timesheet numerical values 122c, actual audit 122d for adjustments and audit values, and actions 122e. The header definition 122a includes the various user interface categories. For instance, the header may include the timesheet owner's name, the creator's name, the period it belongs to, what a user named the timesheet, a comment about it, or other general information that summarizes the logical timesheet. The actual audit table definition 122d is used to double check, for example that planned time equals an actual time or for a user to enter a change. The action table definition 122e is used for timesheet actions such as manager approvals. The line definition 122b is logical information that calculate values per actuals, which are the different categories of work.

As briefly described above, the TDCA 129, the project server infrastructure 132, the IIS 118, and the SQL server 133 work in conjunction to populate the timesheet dataset 120. The timesheet dataset 120 is designed to be consumed by any HTML user interface and adapted to any user interface. The TDCA 129 creates the timesheet data set and populates database tables in the SQL server 135 in support of that dataset 120. The table definitions 122a-122e are logical structures that contain a definition of tables and columns in one memory object called a dataset. Each definition 122 represents a different logical piece of the overall logical timesheet.

The SQL server 133 is used for permanent storage of data. The data may be temporary or transitory data but permanent storage of the needed data resides at the SQL server 133. The IIS 118 is used for communications between the project server infrastructure 132 and the timesheet data set 120. The IIS 118 is a communications server that handles all the network traffic and data communications.

Data values used to populate the dataset 120 are stored in binary large objects (BLOB) or a structured database. A BLOB is a coded structure optimized for individual applications. Thus, the project infrastructure has a binary structure for a depth of applications. A project time phased BLOB 135 and a project calendar BLOB are stored in the SQL server 133 along with structured task data 139. How to access a BLOB, retrieve the data, pull it out, and configure or manipulate the data into terms that a user can interface with even after compilation is made possible by embodiments of the present invention. The BLOBs contain data that identifies the number of hours scheduled or actually worked and to what days and to whom the hours belong. Embodiments of the present invention interface with the BLOBS through a set of calls which access that data and will pull that data out for our consumption.

The MSD 114 is connected to the CPU 110 through a mass storage controller (not shown) connected to the system bus 112. The MSD 114 and its associated computer-readable media, provide non-volatile storage for the computing device 100. Although the description of computer-readable media contained herein refers to a MSD, such as a hard disk or RAID array, it should be appreciated by those skilled in the art that computer-readable media can be any available media that can be accessed by the CPU 110.

The CPU 110 may store data to and access data from the MSD 114. Data is transferred to and received from the MSD 114 through the system bus 112. The CPU 110 may be a general-purpose computer processor. Furthermore, as mentioned below, the CPU 110, in addition to being a general-purpose programmable processor, may be firmware, hard-wired logic, analog circuitry, other special purpose circuitry, or any combination thereof.

According to various embodiments of the invention, the computing device 100 can operate in a networked environment, as shown in FIG. 1, using logical connections to remote computing devices via network communication, such as an Intranet, or a local area network (LAN). The computing device 100 may connect to the network 117 via a network interface unit 119 and interface with other server and/or client computers such as a client computer 121. A user interface may display the contents of the timesheet dataset 120 via a display screen 123. It should be appreciated that the network interface unit 119 may also be utilized to connect to other types of networks and remote computer systems. A computing device, such as the computing device 100, typically includes at least some form of computer-readable media. Computer readable media can be any available media that can be accessed by the computing device 100. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the computing device 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

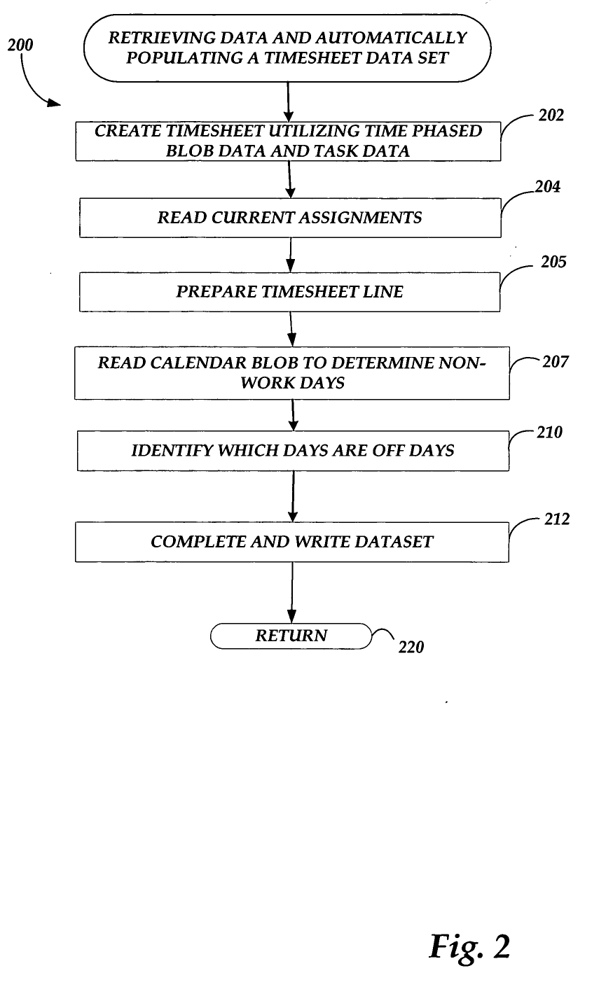

FIG. 2 illustrates an illustrative routine 200 performed in retrieving data to automatically populate a timesheet dataset. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 2, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

Referring now to FIGS. 1-2, the logical flow 200 begins at operation 202, where the computing device 100 creates a timesheet utilizing data from the time phased BLOB 135 and the structured task data 139. Here a user basically creates a timesheet for a particular period of time, for example one week. The computing device 100 reads time phased data from the BLOB 135 thereby initializing the timesheet. Here the computing device 100 gathers scheduled work and actual work assigned to the timesheet user and populates the timesheet dataset with the scheduled and actual work assigned. The computing device 100 also generates a global unique identifier (GUID) associated with the timesheet and persist the GUID in the database 133 therein linking the database and the timesheet dataset 120.

The header table definition 122a in the dataset 120 is used for a user to fill in TS_UID, TS_NAME, TS_COMMENTS, TS_UID, TS_CREATOR_RES_UID, RES_UID and WPRD_UID in the Headers. Also, an enum is provided to indicate a desire to preload projects, assignments, adminTime or a combination of them all. In an alternative embodiment, the user may choose to automatically pre-populate the timesheet dataset with all of the project task assignments available over multiple periods. This may provide too much information to the timesheet dataset.

Next, at operation 204, the computing device 100 reads current assignments or tasks associated with the timesheet into the timesheet dataset. All projects and associated tasks designated for the timesheet user may be read and retrieved from structured tasks data 139. Then at operation 205, the computing device 100 prepares a timesheet line associated with the timesheet based on a single assignment for a timesheet user therein populating the timesheet dataset and enabling access to the timesheet dataset even after compilation. When a user adds a new line to his typed dataset, he knows part of the information, like proj_uid, assn_uid. Operation 205 validates timesheet line information and inputs extra information into the dataset which the user may not know but wants in the dataset, for example, project names and assignment name. The timesheet line is further prepared when the computing device 100 loads actuals into the dataset.

Next, at operation 207, the computing device 100 identifies days off associated with the timesheet user via a read of calendar data from the calendar BLOB 137. Then at operation 210, the days off identified are then populated to the timesheet dataset with an indicator that the days off are scheduled non-working days for the timesheet user. Populating the days off identified to the timesheet dataset with an indicator enables any timesheet application using the timesheet dataset to render the days off identified with a darker background and/or inform the user when overtime is expected. At operation 212, the computing device 100 writes the completed dataset. The dataset may be written for example to an XML file or a screen. The logical flow 200 the returns control to other routines at return operation 220.

APIs illustrating one or more operations described above with respect to FIG. 2 are described and outlined below:

### CreateTimesheet

Description

Purpose: To create a timesheet object and populate it with timesheet line objects.

Parameters:
dsDelta: a typed dataset containing necessary information to create a typed dataset. Actually, only Headers table in the dataset is used. You just need to fill out TS_UID, TS_NAME, TS_COMMENTS, TS_UID, TS_CREATOR_RES_UID, RES_UID and WPRD_UID in the Headers.
preloadType: An enum to indicate if we want to preload projects, assignments, adminTime or a combination of them.
Return value: New timesheet UID if successful. Guid. Empty if failed.
Events:
   Creating/Created.

Test

The test form is available for requests from the local machine.

SOAP 1.1

The following is a sample SOAP 1.1 request and response. The placeholders shown need to be replaced with actual values.

```
POST /SharedServices1/PSI/timesheet.asmx HTTP/1.1
Host: pserv04
Content-Type: text/xml; charset=utf-8
Content-Length: length
SOAPAction: “http://microsoft.com/ProjectServer/CreateTimesheet”
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
    <CreateTimesheet xmlns=“http://microsoft.com/ProjectServer”>
      <dsDelta>dataset</dsDelta>
      <preloadType>Default or None or AdminTimes or Projects or
Assignments or AdminTimesAndProjects or AdminTimesAndAssignments
or ProjectsAndAssignments or All</preloadType>
    </CreateTimesheet>
  </soap:Body>
</soap:Envelope>
HTTP/1.1 200 OK
Content-Type: text/xml; charset=utf-8
Content-Length: length
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
    <CreateTimesheetResponse
xmlns=“http://microsoft.com/ProjectServer” />
  </soap:Body>
</soap:Envelope>
```

SOAP 1.2

The following is a sample SOAP 1.2 request and response. The placeholders shown need to be replaced with actual values.

```
POST /SharedServices1/PSI/timesheet.asmx HTTP/1.1
Host: pserv04
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
    <CreateTimesheet xmlns=“http://microsoft.com/ProjectServer”>
      <dsDelta>dataset</dsDelta>
      <preloadType>Default or None or AdminTimes or Projects or
Assignments or AdminTimesAndProjects or AdminTimesAndAssignments
or ProjectsAndAssignments or All</preloadType>
    </CreateTimesheet>
  </soap12:Body>
</soap12:Envelope>
HTTP/1.1 200 OK
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
    <CreateTimesheetResponse
xmlns=“http://microsoft.com/ProjectServer” />
  </soap12:Body>
</soap12:Envelope>
```

### Sample code to create a timesheet

```
    TimesheetDataSet dsNew = new TimesheetDataSet( );
    TimesheetDataSet.HeadersRow header =
dsNew.Headers.NewHeadersRow( );
    header.TS_UID = Guid.NewGuid( ); //A new guid
    header.TS_NAME = “My timesheet”;
    header.TS_COMMENTS = “My comments”;
    header.TS_ENTRY_MODE_ENUM =
(byte)PJUtility.GetWebAdminSettings(_webAdminSettingsDS,
PSDBField.WADMIN_TS_DEF_ENTRY_MODE_ENUM);
    header.WPRD_UID = periodUID; //A valid period Guid
    header.RES_UID = ResourceUID;//A valid resource Guid
    header.TS_CREATOR_RES_UID = ResourceUID;//A valid
resource Guid
    dsNew.Headers.AddHeadersRow(header);
    PjContext.PSI.TimeSheetWebService.CreateTimesheet(dsNew,
TimesheetEnum.PreloadType.Default);
```

### PrepareTimesheetLine

Description

Purpose: When a user adds a new line to his typed dataset, he only knows part of the information, like proj_uid,assn_uid. He needs to call this PSI to do extra jobs. One thing this API does is to validate his timesheet line information. Then it put extra information which the user may not know but want to know into the dataset, for example, project names and assignment name. Finally, it loads actuals into the dataset.
Parameters:
tsUID: timesheet UID
   dsDelta: the typed dataset need to be processed.
   tlNeedFill: An array of timesheet line UIDs which need to fill actuals with.

Test

The test form is only available for requests from the local machine.

SOAP 1.1

The following is a sample SOAP 1.1 request and response. The placeholders shown need to be replaced with actual values.

```
POST /SharedServices1/PSI/timesheet.asmx HTTP/1.1
Host: pserv04
Content-Type: text/xml; charset=utf-8
Content-Length: length
SOAPAction: “http://microsoft.com/ProjectServer/PrepareTimesheetLine”
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
    <PrepareTimesheetLine xmlns=“http://microsoft.com/ProjectServer”>
      <tsUID>guid</tsUID>
      <dsDelta>dataset</dsDelta>
      <tlsNeedFill>
        <guid>guid</guid>
        <guid>guid</guid>
      </tlsNeedFill>
    </PrepareTimesheetLine>
  </soap:Body>
</soap:Envelope>
HTTP/1.1 200 OK
Content-Type: text/xml; charset=utf-8
Content-Length: length
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
    <PrepareTimesheetLineResponse
xmlns=“http://microsoft.com/ProjectServer”>
      <dsDelta>dataset</dsDelta>
    </PrepareTimesheetLineResponse>
  </soap:Body>
</soap:Envelope>
```

SOAP 1.2

The following is a sample SOAP 1.2 request and response. The placeholders shown need to be replaced with actual values.

```
POST /SharedServices1/PSI/timesheet.asmx HTTP/1.1
Host: pserv04
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
    <PrepareTimesheetLine xmlns=“http://microsoft.com/ProjectServer”>
      <tsUID>guid</tsUID>
      <dsDelta>dataset</dsDelta>
      <tlsNeedFill>
        <guid>guid</guid>
        <guid>guid</guid>
      </tlsNeedFill>
    </PrepareTimesheetLine>
  </soap12:Body>
</soap12:Envelope>
HTTP/1.1 200 OK
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
    <PrepareTimesheetLineResponse
xmlns=“http://microsoft.com/ProjectServer”>
      <dsDelta>dataset</dsDelta>
    </PrepareTimesheetLineResponse>
  </soap12:Body>
</soap12:Envelope>
```

### ReadTimesheet

Description

Purpose: When a user has created a timesheet and at a later time whishes to revisit the timesheet, this method will return all data that is the timesheet to the user.

Parameters:
TSUID: The GUID of the timesheet which will be read.

Test

The test form is only available for requests from the local machine.

SOAP 1.1

The following is a sample SOAP 1.1 request and response. The placeholders shown need to be replaced with actual values.

```
POST /SharedServices1/PSI/timesheet.asmx HTTP/1.1
Host: pserv04
Content-Type: text/xml; charset=utf-8
Content-Length: length
SOAPAction: “http://microsoft.com/ProjectServer/ReadTimesheet”
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
  <ReadTimesheet xmlns=“http://microsoft.com/ProjectServer”>
    <tsUID>guid</tsUID>
  </ReadTimesheet>
  </soap:Body>
</soap:Envelope>
HTTP/1.1 200 OK
Content-Type: text/xml; charset=utf-8
Content-Length: length
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
  <ReadTimesheetResponse xmlns=“http://microsoft.com/ProjectServer”>
    <ReadTimesheetResult>dataset</ReadTimesheetResult>
  </ReadTimesheetResponse>
  </soap:Body>
</soap:Envelope>
```

SOAP 1.2

The following is a sample SOAP 1.2 request and response. The placeholders shown need to be replaced with actual values.

```
POST /SharedServices1/PSI/timesheet.asmx HTTP/1.1
Host: pserv04
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
  <ReadTimesheet xmlns=“http://microsoft.com/ProjectServer”>
    <tsUID>guid</tsUID>
  </ReadTimesheet>
  </soap12:Body>
</soap12:Envelope>
HTTP/1.1 200 OK
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
  <ReadTimesheetResponse xmlns=“http://microsoft.com/ProjectServer”>
    <ReadTimesheetResult>dataset</ReadTimesheetResult>
  </ReadTimesheetResponse>
  </soap12:Body>
</soap12:Envelope>
```

### QueueUpdateTimesheet

Description

Purpose: To update a timesheet's header, line or actuals. Deleting/Adding a timesheet line is also done through this API. Basically, you make all the modification to the typed dataset, then call this method to update the timesheet.

Parameters:
resUID: resource who saves the timesheet. It could be owner, surrogator, approver or adjuster.
tsUID: timesheet UID
dsDelta: Dataset delta.

Test

The test form is only available for requests from the local machine.

SOAP 1.1

The following is a sample SOAP 1.1 request and response. The placeholders shown need to be replaced with actual values.

```
POST /SharedServices1/PSI/timesheet.asmx HTTP/1.1
Host: pserv04
Content-Type: text/xml; charset=utf-8
Content-Length: length
SOAPAction:
“http://microsoft.com/ProjectServer/QueueUpdateTimesheet”
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
  <QueueUpdateTimesheet xmlns=“http://microsoft.com/ProjectServer”>
    <jobUID>guid</jobUID>
    <tsUID>guid</tsUID>
    <dsDelta>dataset</dsDelta>
  </QueueUpdateTimesheet>
  </soap:Body>
</soap:Envelope>
HTTP/1.1 200 OK
Content-Type: text/xml; charset=utf-8
Content-Length: length
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
  <QueueUpdateTimesheetResponse
xmlns=“http://microsoft.com/ProjectServer” />
  </soap:Body>
</soap:Envelope>
```

SOAP 1.2

The following is a sample SOAP 1.2 request and response. The placeholders shown need to be replaced with actual values.

```
POST /SharedServices1/PSI/timesheet.asmx HTTP/1.1
Host: pserv04
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
  <QueueUpdateTimesheet xmlns=“http://microsoft.com/ProjectServer”>
    <jobUID>guid</jobUID>
    <tsUID>guid</tsUID>
    <dsDelta>dataset</dsDelta>
  </QueueUpdateTimesheet>
  </soap12:Body>
</soap12:Envelope>
HTTP/1.1 200 OK
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
  <QueueUpdateTimesheetResponse
xmlns=“http://microsoft.com/ProjectServer” />
  </soap12:Body>
</soap12:Envelope>
```

### TimeSheetReadTimesheetDaysOff

SOAP 1.1

The following is a sample SOAP 1.1 request and response. The placeholders shown need to be replaced with actual values.

```
POST /DefaultSSP_DevInstall/PSI/pwa.asmx HTTP/1.1
Host: xfu5150
Content-Type: text/xml; charset=utf-8
Content-Length: length
SOAPAction:
“http://schemas.microsoft.com/office/project/server/webservices/
PWA/Time SheetReadTimesheetDaysOff”
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
    <TimeSheetReadTimesheetDaysOff
xmlns=“http://schemas.microsoft.com/office/project/server/webservices/
PWA/”>
      <resUID>guid</resUID>
      <start>dateTime</start>
      <finish>dateTime</finish>
    </TimeSheetReadTimesheetDaysOff>
  </soap:Body>
</soap:Envelope>
HTTP/1.1 200 OK
Content-Type: text/xml; charset=utf-8
Content-Length: length
<?xml version=“1.0” encoding=“utf-8”?>
<soap:Envelope
xmlns:xsi=“http://www.w3.org/2001/XMLSchema-instance”
xmlns:xsd=“http://www.w3.org/2001/XMLSchema”
xmlns:soap=“http://schemas.xmlsoap.org/soap/envelope/”>
  <soap:Body>
    <TimeSheetReadTimesheetDaysOffResponse
xmlns=“http://schemas.microsoft.com/office/project/server/webservices/
PWA/”>
<TimeSheetReadTimesheetDaysOffResult>dataset</
TimeSheetReadTimesheetDaysOffResult>
    </TimeSheetReadTimesheetDaysOffResponse>
  </soap:Body>
</soap:Envelope>
```

SOAP 1.2

The following is a sample SOAP 1.2 request and response. The placeholders shown need to be replaced with actual values.

```
POST /DefaultSSP_DevInstall/PSI/pwa.asmx HTTP/1.1
Host: xfu5150
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
    <TimeSheetReadTimesheetDaysOff
xmlns=“http://schemas.microsoft.com/office/project/server/webservices/
PWA/”>
      <resUID>guid</resUID>
      <start>dateTime</start>
      <finish>dateTime</finish>
    </TimeSheetReadTimesheetDaysOff>
  </soap12:Body>
</soap12:Envelope>
HTTP/1.1 200 OK
Content-Type: application/soap+xml; charset=utf-8
Content-Length: length
<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>
  <soap12:Body>
    <TimeSheetReadTimesheetDaysOffResponse
xmlns=“http://schemas.microsoft.com/office/project/server/webservices/
PWA/”>
<TimeSheetReadTimesheetDaysOffResult>dataset</
TimeSheetReadTimesheetDaysOffResult>
    </TimeSheetReadTimesheetDaysOffResponse>
  </soap12:Body>
</soap12:Envelope>
```

Thus, the present invention is presently embodied as methods, systems, computer program products or computer readable mediums encoding computer programs for retrieving data to automatically populate a timesheet dataset.

It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

We claim:

1. A method for retrieving data to automatically populate a timesheet dataset, the method comprising:
creating a timesheet via a read of time phased data from a binary large object (BLOB) therein initializing a timesheet dataset;
reading current assignments associated with the timesheet into the timesheet dataset; and
preparing a timesheet line associated with the timesheet based on a single assignment for a timesheet user therein populating the timesheet dataset and enabling access to the timesheet dataset after compilation.

2. The method of claim 1, further comprising:
identifying days off associated with the timesheet user via a read of calendar data from a calendar BLOB; and
populating the days off identified to the timesheet dataset with an indicator that the days off are non-working days for the timesheet user.

3. The method of claim 1, further comprising writing the timesheet dataset to an XML file.

4. The method of claim 1, further comprising writing the timesheet dataset to a screen.

5. The method of claim 1, wherein creating the timesheet comprises:
gathering scheduled work and actual work assigned to the timesheet user; and
populating the timesheet dataset with the scheduled and actual work assigned.

6. The method of claim 1, wherein creating a timesheet comprises creating a timesheet covering a specified period of time therein populating a database with all of the current assignments the timesheet user has over the specified period of time.

7. The method of claim 6, wherein creating the timesheet comprises:
generating header information for the timesheet in the timesheet dataset; and
generating a global unique identifier (GUID) associated with the timesheet; and
persisting the GUID in the database therein linking the database and the timesheet dataset.

8. The method of claim 1, wherein reading the current assignments comprises:
retrieving from structured tasks data all projects and associated tasks designated for the timesheet user.

9. The method of claim 1, wherein preparing a timesheet line comprises:
receiving a unique identifier for a line associated with a task; and
returning relative information associated with the line wherein the relative information comprises at least one of the following:
project name;
task name;
name of user to whom the task is assigned;
actual time worked;
actual audit; and
actions.

10. The method of claim 2, wherein populating the days off identified to the timesheet dataset with an indicator comprises enabling any timesheet application using the timesheet dataset to at least one of the following:
render the days off identified with a darker background; and
inform the user when overtime is expected.

11. A computer program product comprising a computer-readable medium having control logic stored therein for causing a computer to retrieve data to automatically populate a timesheet dataset, the control logic comprising computer- readable program code for causing the computer to create a timesheet via a read of time phased data from a binary large object (BLOB) therein initializing a timesheet dataset.

12. The computer program product of claim 11, further comprising computer-readable program code for causing the computer to:
read current assignments associated with the timesheet into the timesheet dataset; and
prepare a timesheet line associated with the timesheet based on a single assignment for a timesheet user therein populating the timesheet dataset and enabling access to the timesheet dataset after compilation.

13. The computer program product of claim 11, further comprising computer-readable program code for causing the computer to:
identify days off associated with the timesheet user via a read of calendar data from a calendar BLOB; and
populate the days off identified to the timesheet dataset with an indicator that the days off are non-working days for the timesheet user.

14. The computer program product of claim 11, further comprising computer-readable program code for causing the computer to write the timesheet dataset to an XML file or to a screen.

15. The computer program product of claim 11, wherein the computer-readable program code for causing the computer to create the timesheet comprises computer-readable program code for causing the computer to:
gather scheduled work and actual work assigned to the timesheet user; and
populate the timesheet dataset with the scheduled and actual work assigned.

16. The computer program product of claim 11, wherein the computer-readable program code for causing the computer to create a timesheet comprises computer-readable program code for causing the computer to create a timesheet covering a specified period of time therein populating a database with all of the current assignments the timesheet user has over the specified period of time.

17. The computer program product of claim 16, wherein the computer-readable program code for causing the computer to create a timesheet comprises computer-readable program code for causing the computer to:
generate header information for the timesheet in the timesheet dataset; and
generate a global unique identifier (GUID) associated with the timesheet; and
persist the GUID in the database therein linking the database and the timesheet dataset.

18. The computer program product of claim 11, wherein the computer-readable program code for causing the computer to populate the days off identified to the timesheet dataset with an indicator comprises computer-readable program code for causing the computer to enable any timesheet application using the timesheet dataset to at least one of the following:
render the days off identified with a darker background; and
inform the user when overtime is expected.

19. A system for retrieving data to automatically populate a timesheet dataset, the system comprising a server computer having an infrastructure operative to:
create a timesheet via a read of time phased data from a binary large object (BLOB) therein initializing a timesheet dataset and enabling any timesheet application to read and interpret the timesheet dataset;
read current assignments associated with the timesheet into the timesheet dataset; and
prepare a timesheet line associated with the timesheet based on a single assignment for a timesheet user therein populating the timesheet dataset and enabling access to the timesheet dataset after compilation.

20. The system of claim 19, wherein the infrastructure is further operative to:
identify days off associated with the timesheet user via a read of calendar data from a calendar BLOB; and
populate the days off identified to the timesheet dataset with an indicator that the days off are non-working days for the timesheet user.
